(19) United States
(12) Patent Application Publication
(10) Pub. No.: US 2015/0075987 A1
(43) Pub. Date: Mar. 19, 2015

(54) DEVICES AND METHODS FOR SEPARATING NANOPARTICLES

(71) Applicant: University of Utah Research Foundation, Salt Lake City, UT (US)

(72) Inventors: Tonguc Onur Tasci, Salt Lake City, UT (US); Bruce K. Gale, Taylorsville, UT (US); William P. Johnson, Salt Lake City, UT (US)

(21) Appl. No.: 14/325,591

(22) Filed: Jul. 8, 2014

Related U.S. Application Data
(60) Provisional application No. 61/843,815, filed on Jul. 8, 2013.

(51) Int. Cl. G01N 27/447

(52) U.S. Cl. CPC G01N 27/44791
USPC 204/451; 204/601

(57) ABSTRACT

A device and related method for separating nanometer particles is disclosed and described. The device can include a microfluidic system including a sample input port, a fluid flow channel, and a sample output port, in which the fluid flow channel is defined by a pair of electrode walls and an insulator. A voltage device is electrically coupled to the electrode walls. The voltage device is comprised of a diode or a resistor configured to provide an electrical field within the fluid flow channel suitable for separation of nanoparticles from one another by causing a net effect of moving particles toward one of the electrode walls.

### PRIORITY CLAIM

The present application claims the benefit of U.S. Provisional Patent Application No. 61/843,815, filed on Jul. 8, 2013, which is incorporated herein by reference in its entirety.

### GOVERNMENT INTEREST

This invention was made with government support under Grant CBT-0967037 awarded by the National Science Foundation. The Government has certain rights in the invention.

### BACKGROUND

Currently, nanoparticles are gaining more and more attention in the fields of medicine, biology, chemistry, electronics, physics, energy, etc. As demand for all different kinds of nanoparticles increases, the need for analytical techniques used for the characterization and separation of nanoparticles also increases. Several methods such as chromatography, electrophoresis, and ultracentrifugation are used for the separation and characterization of nanoparticles. In addition to these techniques, Field Flow Fractionation (FFF) is also a powerful method that is likewise used.

In Field Flow Fractionation, separation occurs in a ribbon-like channel, through which the carrier liquid is passed. Carrier flow is laminar and has a parabolic velocity profile. Perpendicular to this flow, a separation field is applied, which causes the particles to migrate at different velocities down the channel. Based on the interaction level of the particles with the separation field, migration rates differ between the particles and accordingly the separation occurs.

### SUMMARY

An Electrical Field Flow Fractionation (EFFF) or Cyclical Electrical Field Flow Fractionation (CyEFFF) device can comprise a microfluidic system including a sample input port, a fluid flow channel, and a sample output port. The fluid flow channel can be defined by a pair of electrode walls and an insulator. The device can also comprise a voltage device electrically coupled to the electrode walls, the voltage device comprising a diode or a resistor configured to provide electrical field within the fluid flow channel suitable for separation of nanoparticles from one another by causing a net effect of moving particles toward one of the electrode walls.

In another example, a method of separating nanoparticles can comprise flowing a nanoparticle dispersion including the nanoparticles through the fluid flow channel of a EFFF or CyEFFF device described above. An additional step can include applying cyclic or DC offset voltage to the electrode walls to increase retention time of nanoparticles. As the nanoparticles move toward one of the electrode walls, a first group of nanoparticles is slowed to a greater degree than a second group of nanoparticles.

There has thus been outlined, rather broadly, features of the disclosure so that the detailed description thereof that follows may be better understood, and so that the present contribution to the art may be better appreciated. Other features of the present disclosure will become clearer from the following detailed description, taken with the accompanying drawings and claims.

### BRIEF DESCRIPTION OF THE DRAWINGS

FIG. 1 is a diagrammatic representation of the operation principle of a typical CyEFFF system. The plot shows the motion of two particles (having different electrophoretic mobilities) for 3 cycles of applied square wave voltage. The Figure is not drawn to scale; it is rescaled for better visualization of particle motions. In an original EFFF systems, channel length can be at least 100 times longer than the channel height.

FIG. 2 depicts the particle trajectories in a CyEFFF system, for 2.5 cycles of a square voltage, wherein A) represents the trajectory when there is no voltage offset condition and diffusion is occurring in the positive x-direction causing the particle to move away from the channel wall (resulting in particle gaining a higher z-velocity and moving faster in each cycle, which reduces the retention time); and wherein B) represents particle trajectory when a positive voltage offset is present and diffusion in the x-direction is controlled (since E⁺_{eff} is greater than the E⁻_{eff}, in each cycle, particles are attracted to the channel wall, and high retention times can be obtained).

FIG. 3 represents electrical circuitry of CyEFFF systems, wherein A) depicts a typical CyEFFF system circuit; and wherein B) represents the electrical circuitry of a modified CyEFFF system.

FIG. 4 shows UV fractograms for the separations made with the regular and modified circuits, in the presence and absence of the offset voltage.

FIG. 5 shows UV fractograms for different voltage offsets.

FIG. 6 shows UV fractograms for the determination of which peaks corresponds to the 15 and 40 nanometer particles.

FIG. 7 shows UV fractograms for varied voltages amplitudes.

FIG. 8 shows UV fractograms when the frequency was varied.

FIG. 9 shows UV fractograms for the different voltage shapes.

FIG. 10 shows various separation resolutions, wherein A) A shows separation resolutions as the offset voltage is varied; and wherein B) shows separation resolutions as voltage amplitude is varied; and C) shows separation resolutions as the frequency is varied.

These drawings are provided to illustrate various aspects of the invention and are not intended to be limiting of the scope in terms of dimensions, materials, configurations, arrangements or proportions unless otherwise limited by the claims.

### DETAILED DESCRIPTION

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

As used in this specification and the appended claims, the singular forms “a,” “an” and “the” include plural referents unless the context clearly dictates otherwise. Thus, for example, reference to “a diode” includes a plurality of diodes. In this specification and in the claims that follow, reference will be made to a number of terms that are defined to have the following meanings.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the suitable methods and materials are now described.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

As used herein, the following terms have the meanings ascribed to them unless specified otherwise. In this disclosure, “comprises,” “comprising,” “containing” and “having” and the like can have the meaning ascribed to them in U.S. Patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. Additionally, “consisting essentially of or “consists essentially” or the like, when applied to methods and compositions encompassed by the present disclosure have the meaning ascribed in U.S. Patent law and the term is open-ended, allowing for the presence of more than that which is recited (e.g., trace contaminants, components not reactive with the polymer or components reacted to form the polymer, and the like) so long as basic or novel characteristics of that which is recited is not changed by the presence of more than that which is recited, but excludes prior art embodiments.

The ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

“Field Flow Fractionation” has several sub-techniques which differ with the type of the separation field applied. The major sub-techniques are electrical FFF, magnetic FFF, thermal FFF, gravitational FFF, and flow FFF. In electrical field flow fractionation or “EFFF,” the separation field is electric, which is produced by applying voltages to the top and bottom walls of the EFFF channel. In this method, particles are separated according to their sizes and electrophoretic mobilities. EFFF has also a related method which is called Cyclical Electrical Field Flow Fractionation or “CyEFFF.” This technique differs from the traditional EFFF by means of the type of the applied voltage. In CyEFFF, alternating (cyclical) voltages are used rather than a static (constant) voltage. Cyclical voltages help to alleviate the disadvantages of electrical double layer formation (EDL) on the channel walls. When static voltages are applied in the traditional EFFF method, EDL is fully formed and electric field inside the channel drops to 3% of its initial value. In CyEFFF, on the other hand, since polarization changes in each cycle, insufficient time exists for the EDL to be formed completely and most of the initial electric field is preserved. Compared to other sub-techniques of FFF, CyEFFF is a fairly new method that is still being improved, but generally, is a technique for the separation of macromolecular, colloidal, and nanometer-sized particles. In many CyEFFF techniques, separations have been achieved for only particles bigger than about 70 nm to 100 nm. For the particles smaller than about 70 nm to 100 nm, diffusion rate becomes very high and this results in severe reductions in the CyEFFF separation efficiency. Thus, without limitation, it would be an advancement in the art to develop techniques and systems for separating particles smaller than about 100 nm.

With this in mind, as mentioned, with certain EFFF techniques including more specifically, some CyEFFF techniques, separations can be achieved primarily for particles bigger than about 70 nm to 100 nm. For the particles smaller than about 70 nm to 100 nm, diffusion rate becomes very high and this results in severe reductions in the EFFF separation efficiency. Thus, it would be a significant advancement in the art to develop techniques and systems for separating particles smaller than about 100 nm, or even smaller than about 70 nm. In accordance with examples of the present disclosure, the separation capability of the EFFF systems can be significantly improved by modifying the electrical circuit using additional circuit components, such as a diode and/or a resistor as described herein. Using this circuit modification and/or applying current in a certain manner, EFFF methods can become capable of separating particles smaller than 50 nm, including particles as small as 5 nm in some examples. With this approach, by controlling the diffusion of nanoparticles, the separation of small nanoparticles becomes possible. It is noted that there are other separation techniques such as chromatography and electrophoresis but the open channel characteristic of the EFFF systems allows easy elution and collection of samples from the channel outlet. Furthermore, as a result of the open channel geometry, shear stresses in the EFFF channels are low, which permits separation of fragile samples as well. In addition, the fabrication of the EFFF channel is simpler than the fabrication of the aforementioned systems.

In further detail with specific reference to the EFFF approaches and

CyEFFF approaches of the present disclosure, in order to separate particles smaller than about 100 nm or about 70 nm, diffusion of the nanoparticles can be controlled by modification of the electrical circuitry of more typical EFFF systems. In earlier EFFF work, electrical power sources have been directly connected to the EFFF channel walls, and no alteration has been made in the electrical circuitry of the system. By using lumped electrical components, such as resistors and diodes, the electrical circuitry of the system is changed effectively to improve the effective electric field inside the system so that high resolution separations become possible. In addition to the circuit modification of the system, DC offset voltages (besides cyclical voltages) can be used to improve the EFFF or CyEFFF separation performance.

Offset voltages can be used to improve the particle relaxation process for preventing the particles to elute in the void or early peak. For example, offset voltages can be used to obtain high retention times in the channel. In accordance with the present disclosure, however, offset voltage can also be used not only for improving the retention time, but also can be used to achieve high efficiency separations in the EFFF technique. Mainly, by using electrical circuit modification together with offset voltage application, suppression of the limiting effect of the nanoparticle diffusion and baseline separations of sub 50 nm particles can be achieved. Basically, separations of 15 nm and 40 nm gold nanoparticles have been shown to be achievable, which is among some of the first baseline separations in the sub-100 nm particle-size accomplished by an EFFF system. Thus, this separation technique can be used as a much more effective tool in the fractionation of nanoparticles and macromolecules. For example, a modified circuit CyEFFF can be used for the separation and characterization of charged nanoparticles and biomolecules (cells, proteins, amino acids, nucleic acids, etc.) with sizes less than 100 nm.

It is notable that this technique works well in highly resistive fluids (DI water, solvents, etc.), but can be used with conductive solutions as well within a range, provided the particles of interest have electrophoretic mobility within the fluid. The system works through simple modifications to the electrical circuit driving the EFFF system.

In one example of the structure of the device, the fluid flow channel is typically defined on two opposing sides by the pair of electrodes (e.g., side to side) and a pair of insulating spacers (e.g., top to bottom), or vice versa. The electrode walls can be the electrodes themselves in the form of solid electrode walls, or can be electrodes coupled with electrically porous material in contact with the fluid flow channel.

In further detail regarding the fabrication, these EFFF systems can be prepared by locating a thin Mylar spacer (defining the channel) between 2 electrodes. The flow inside the EFFF or CyEFFF channel is laminar with a parabolic velocity profile. As the cyclical voltages are applied on the channel walls (electrodes), particles move back and forth between the electrodes. In each cycle, according to their mobilities, particles spend more or less time in the faster fluid regions. Particles spending more time close to middle of the channel elute earlier, whereas particles spending more time close to the channel wall elute later.

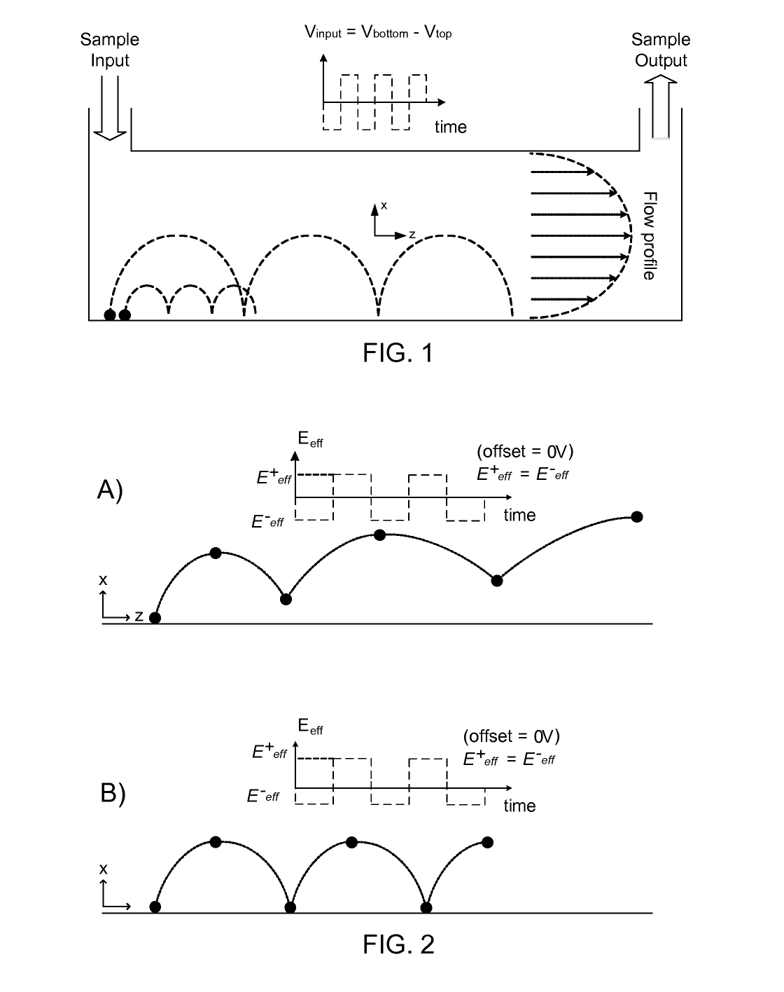

To provide one example, the operation principle of a CyEFFF system can be seen in FIG. 1. In this example, trajectories of particles having two different electrophoretic mobilities are presented for 3 cycles of a square voltage application. In each cycle, the particle having a higher electrophoretic mobility reaches closer to the middle of the channel. As a result, that particle moves much faster throughout the channel (in the z-direction). The particle having lower electrophoretic mobility mostly stays closer to the channel wall, moving much slower in the z-direction and elutes later than the higher mobility particle. In further detail, FIG. 1 also sets forth the operation principle of a typical CyEFFF system. The plot shows the motion of two particles (having different electrophoretic mobilities) for 3 cycles of applied square wave voltage. Note that FIG. 1 has been rescaled for better visualization of particle motions). In typical and original EFFF systems, the channel length is typically at least 100 times longer than the channel height.

The velocity of a nanoparticle under the influence of an electric field can be represented by the equation 1 below:

vₚ=μₚ×E_{eff}

where vₚ(m/s) is the velocity of the particle, μₚ (m²Vs) is the electrophoretic mobility of the particle, and E_{eff}(V/m) is the effective electric field inside the channel. As shown in the equation, to increase the electrically driven velocity of a nanoparticle, effective electric field (E_{eff}) can be increased.

As previously stated, nanoparticles also move as a result of diffusion (Brownian motion). The diffusion length traversed by a particle in a given time is stated by the following equation:

l_{d}=\sqrt{2Dt}

where D (m²/s) is the diffusion coefficient of the particle and t (s) is time. The diffusion coefficient of a spherical particle can be calculated using the Stokes-Einstein equation, as follows:

$$D = \frac{{TK}_{b}}{3 π η R}$$

where T (K) is temperature, K_{b} (J/K) is Boltzmann's constant, η(Pa·s) is the dynamic viscosity of the carrier liquid and R(m) is the particle diameter.

The Stokes-Einstein equation shows that particle diffusion rate is higher for smaller particles. As stated, particle diffusion is a big limitation for the CyEFFF technique. This is particularly the case in the diffusion occurring in the +x direction which has the most negative effect in the separation efficiency.

FIGS. 2(A and B) represents particle trajectories in a CyEFFF system, for 2.5 cycles of a square voltage. FIG. 2A in particular provides particle trajectory in a typical CyEFFF system for 2.5 cycles of a square wave. As a consequence of the particle diffusion in the +x direction, the particle moves away from the channel wall during each cycle, and gains a faster speed. While particle moves faster and faster throughout the channel, its retention time significantly drops and separation efficiency reduces drastically. To suppress the detrimental effect of particle diffusion on the separation efficiency, diffusion in the +x direction may be controlled. Thus, in this example, there is no offset condition. Diffusion occurring in the positive x-direction causes the particle to move away from the channel wall. As a result, particle gains a higher z-velocity and moves faster in each cycle, which reduces the retention time.

FIG. 2B represents this situation where the application of DC offset voltages is used along with cyclical square wave voltages. By applying offset voltages, the electric field inside the channel is modified such that the positive component of the electric field E_{eff} becomes higher than the negative component E_{eff} (i.e., electric field profile shifts up). As a result, even though the particle diffuses in the +x direction, high E_{eff} forces the particle to return back to the channel wall (x=0). By this way, particle keeps its longitudinal velocity (z-velocity) during each cycle, and much longer retention times can be obtained compared to the no offset condition. Thus, in this example, there is a positive offset condition. Diffusion in the x-direction is controlled. Since E⁺_{eff} is bigger than the E⁻_{eff}, in each cycle, particles are attracted to the channel wall, and high retention times can be obtained.

Even if the application of offset voltages seems reasonable for controlling diffusion, it is not always sufficient. The reason for that stems from the parallel plate capacitor behavior of the EFFF channel. As a result of this capacitive behavior, offset in the effective field can decay to less than 5% of its initial value, and this small increase in the effective field can be insufficient to control the diffusion of small nanoparticles (smaller than 100 nm). Consequently, a supplemental method can also be used to efficiently overcome the diffusion problem of the CyEFFF systems.

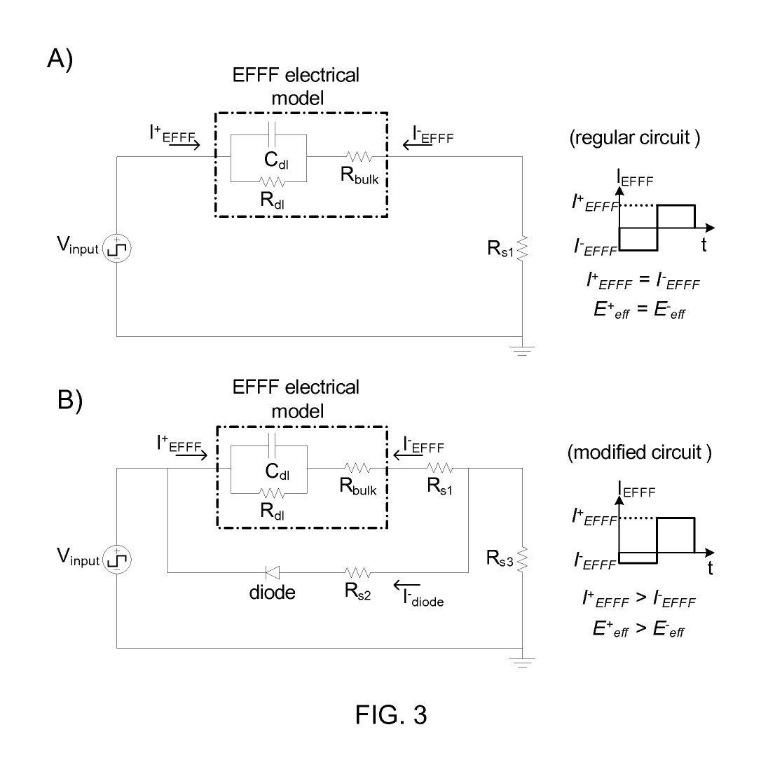

FIGS. 3(A and B) represents the electrical circuitry of CyEFFF systems. Specifically, FIG. 3A depicts an electrical circuitry of a regular CyEFFF system, and FIG. 3B represents electrical circuitry of a modified CyEFFF system in accordance with examples of the present disclosure. In both examples, the part surrounded by a hashed line square is the electrical circuit equivalent of the EFFF channel. C_{dl} is the capacitance representing the electric double layer at the channel walls. R_{dl} is the resistance of the electrical double layer, and R_{bulk} symbolizes the resistance of the carrier between the channel walls. The resistance Rₛ₁ is connected in series to the EFFF system to monitor the current flowing through the channel. By measuring the voltage on Rₛ₁ and dividing it by its resistance value, one can obtain the current flowing through the system. Among the circuit components explained, R_{bulk} has a significant role because the effective field (E_{eff}) is directly proportional to the R_{bulk} value, as shown in the following equation:

$${E}_{eff} ( t ) = \frac{{I}_{EFFF} ( t ) \times {R}_{bulk}}{h}$$

where E_{eff} can be found by multiplying the R_{bulk} resistor with the current flowing through the channel (I_{EFFF}), and dividing the result by the channel height h(m). Again from this equation, it is clear that effective field can be proportional to the current flowing through the channel (I_{EFFF}). This demonstrates that one can play with the current I_{EFFF} to alter the effective field inside the channel.

FIG. 3A also shows the situation when a square wave voltage is applied to the CyEFFF system. In this case, since the voltage is symmetric, the positive component of the current I⁺_{EFFF} has the same magnitude with the negative component I⁻_{EFFF}. Accordingly, positive component of the effective field E⁺_{eff} has the same amplitude with the negative component E⁻_{eff}. Because higher E⁺_{eff} values do not overcome the diffusion, the regular CyEFFF circuit depicted in FIG. 3A does not help to control the diffusion.

Electrical circuitry of a regular CyEFFF system can be modified by using a diode and additional resistors to achieve an imbalance between E⁺_{eff} and E⁻_{eff}. As shown in FIG. 3B, a diode is connected in parallel to the EFFF channel. The diode operates such that it allows the current to flow in only one direction. As a consequence, when the input voltage is positive, the current only flows through the channel. On the contrary, while the input voltage is negative, current flows through both the channel and the diode. Thus, during the negative cycle of the input, current divides into two and resulting I⁻_{EFFF} becomes smaller than I⁺_{EFFF}. By this circuit modification, even if the voltage input does not include any offset voltage, one can achieve an offset in the I_{EFFF} profile. Accordingly, the positive shift in the E_{eff} profile (i.e., E⁺_{eff}>E⁻_{eff}) can be obtained and controlling the particle diffusion in the +x direction becomes possible.

The remaining circuit elements in FIG. 3B, Rₛ₁ and Rₛ₂ include small resistors to monitor the current flowing through the EFFF and diode branches. A small resistor Rₛ₃ (in the order of 10) can be added in series to the parallel EFFF-diode network. In this specific example, if it is not connected, then diode will have no effect on the I_{EFFF} current, since it would be directly connected between the power source and the ground. Typically, all the resistors Rₛ₁, Rₛ₂ and Rₛ₃ can be selected with low values (e.g., 0.1Ω<Rₛ<50Ω, or more typically, 1Ω<Rₛ<10Ω) because the effective field inside the channel decreases as the values of these resistors increase.

### EXAMPLES

### Example 1

### Particles for Separation and General Conditions

A mixture of 15 nm and 40 nm spherical gold nanoparticles (Nano-Composix, CA, USA) was used as the sample to be separated. Particles were stabilized with tannic acid and their mass concentration was 0.05 mg/mL. Particle sizes and electrophoretic mobilities were measured using a Zetasizer Nano ZS instrument (Malvern Instruments Ltd., UK), and tabulated in Table 1 below.

TABLE 1
Properties of the particles used in the separation experiments

| | Particle #1 | | Particle #2 | |
|---|---|---|---|---|
| Material | Gold | | Gold | |
| Manufacturer size | 15 | nm | 40 | nm |
| Hydrodynamic diameter | 17.6 ± 0.3 | nm | 45.1 ± 0.8 | nm |
| Electrophoretic | −3.55 | μmcm/Vs | −3.41 | μmcm/Vs |
| mobility | | | | |

De-ionized water (18.2 MΩ/cm) was used as the carrier liquid and was pumped at a flow rate of 1 mL/min by an HPLC pump (Alltech model 426, Alltech Associates, Inc., Ill., USA). AC and DC voltages were applied using an Agilent signal generator (Model 33120A) and an Agilent DC power supply (Model E3640A), respectively. For the detection of the nanoparticles, a UV/Vis detector (ESA-Model 520) was used at the wavelength of 520 nm. The UV detector data, the electrical current flowing through the EFFF system, and the potential difference between the channel walls were measured using a LabView (National Instruments) data acquisition card. To measure the currents flowing through the branches, voltages on the Rₛ₁, Rₛ₂ and Rₛ₃ resistors were monitored. The values for these resistors were selected as 5.4Ω, 5.4Ω and 1.0Ω respectively.

The EFFF channel measured 64 cm in length, 178 μm in height, and 2 cm in width. 40 μL of a 15 & 40 nm gold nanoparticle mixture was injected using a 100 μL Hamilton microliter syringe. The nanoparticle mixture was injected into to the EFFF channel at t=0. Immediately following the injection, at t=0⁺, 1V DC voltage was applied for 1 minute. In this particle relaxation step, all particles were attracted to the channel wall surface. At t=1 min, the HPLC pump was turned on to flow the mixture through the system. At the same time, square wave voltage was applied to the system using the signal generator. Cyclical voltage continued from 35 to 40 minutes, after which the power was discontinued.

### Example 2

### Comparison of Separation Performance with the Regular and Modified Circuit in the Presence and Absence of the Offset Voltage

Separations were made in the presence and absence of a 1.3V offset voltage. Additionally, comparisons were made with and without the modified circuit to investigate the effect of the circuit modification on the separation efficiency. The amplitude of the cyclical voltage was selected as 16 Vpp and the frequency was chosen as 15 Hz (f=15 Hz, Vamp=16 Vpp).

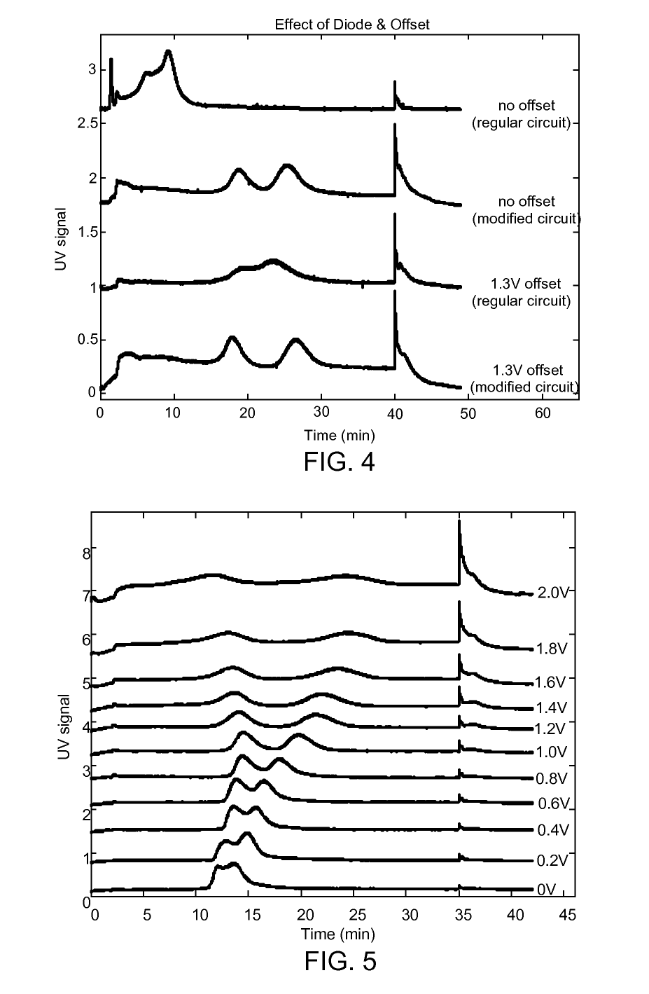

FIG. 4 depicts UV fractograms for combinations made with the regular and modified circuits, in the presence and absence of the offset voltage. The UV fractogram for no offset condition with the regular circuit, shows that there is hardly any separation between 15 and 40 nm particles. Additionally, the retention times for these particles are less than 10 minutes. In contrast, for the no offset condition but with the circuit modification, the 15 and 40 nm particles are well separated, with retention times being approximately 19 and 26 minutes. Thus, even in the absence of any offset voltage, retention times are extensively increased with the circuit modification of the system. Additionally, baseline separation of the particles is achieved, which is the first reported baseline separation of sub 50 nm particles with the CyEFFF technique. The fractogram for 1.3V offset application with the regular circuit shows that retention times are increased significantly as well. However, separation of the 15 and 40 nm particles was not complete, demonstrating that the offset voltage application is a useful method for obtaining high retention times but may not always produce baseline separation of sub 50 nm particles. The fractogram on the bottom of the FIG. 4 shows the result when the circuit modification and offset application methods are applied together. As shown, by combining these two methods, very high resolution separations of 15 and 40 nm particles becomes possible, which is a significant improvement over previously existing CyEFFF methods.

The response at t=40 min is the instant that the power is turned off. The power-off response is very low for no offset condition with the regular circuit. A comparably higher response in the other fractograms, indicates that as offset voltages are applied, or the circuit is modified, some of the particles are trapped in the channel and they are released upon elimination of the electrical field.

### Example 3

### The Effect of the Offset Voltage on the Separation Efficiency of the CyEFFF System

Using the modified CyEFFF circuit, offset voltages from 0V to 2V were applied. The offset voltage was limited to a maximum of 2V because at voltages greater than 2V, electrolysis of the carrier liquid occurred, generating air bubbles in the channel, thus preventing nanoparticle separation. The remaining electrical parameters were Vamp=8 Vpp and f=10 Hz. The offset voltage which produced the highest resolution was picked and denoted as Vₒₚₜᵢₘᵤₘ.

FIG. 5 depicts UV fractograms for the offset comparisons. Different offset values were applied, while the voltage amplitude was 8 Vpp and the frequency was 10 Hz. The UV fractogram on the bottom of FIG. 5 corresponds to the no offset condition and the one on the top is for the 2 V offset condition. The fractogram for 0V offset case reveals that in the absence of the offset voltage, high retention times (around 13 min) can still be obtained. However, to achieve complete separation, offset voltage may be increased. As shown in FIG. 5, for offset voltages greater than or equal to 1.0V, baseline separations were achieved. However, for the high offset voltage of 2V, the separation resolution starts to drop and peaks become wider. The highest resolution was obtained for the offset voltage of 1.4 V (see Table 2) and this offset value was denoted as Vₒₚₜᵢₘᵤₘ. Thus, offset voltage helps to achieve higher resolution separations and may be used in combination with the circuit modification method.

The power off responses at t=35 min show that the power off response grows with the increasing offset voltage. This indicates that more particles are trapped in the channel with higher offset application; nonetheless, there was no appreciable effect on the quality of the separation.

### Example 4

### Peak Determination

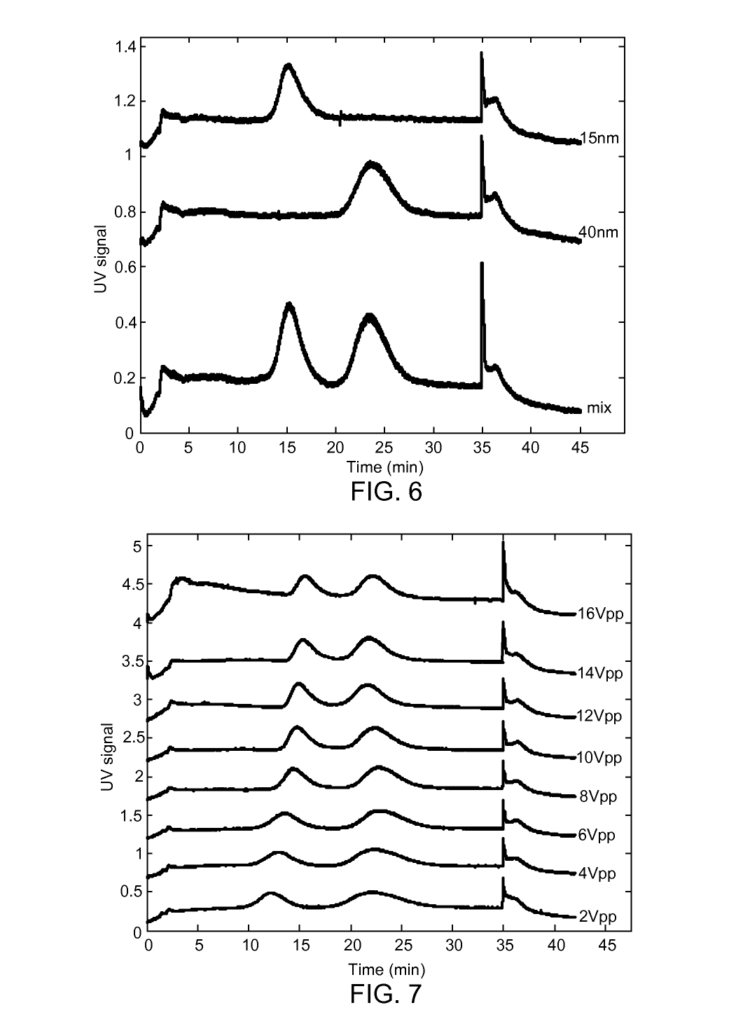

FIG. 6 shows which particles (15 or 40 nm particle) correspond to the first and second peaks in the UV fractograms. Using the modified CyEFFF circuit, the voltage parameters were held constant at Vamp=8 Vpp, f=10 Hz, Voffset=Vₒₚₜᵢₘᵤₘ. For the individual injection of 15 nm particles, a peak was observed around t=15 min; for the individual injection of 40 nm particles, the peak was located around t=23 min. This result is in agreement with the electrophoretic mobilities of the particles (see Table 1). Since 15 nm particles have a higher electrophoretic mobility, and move further away from the channel wall in each cycle. Consequently, as a result of the parabolic flow profile, the 15 nm particles migrate faster and elute earlier than the 40 nm particles.

### Example 5

### Amplitude Comparison

FIG. 7 depicts how altering the voltage amplitude affects the resolution of the separations. Using the modified CyEFFF circuit, square wave voltage amplitudes ranging from 2 Vpp to 16 Vpp were applied. Remaining electrical parameters were: f=10 Hz and Voffset=Vₒₚₜᵢₘᵤₘ=1.4V. As shown in FIG. 7, there is no significant difference in separation resolution, although the highest resolution corresponds to the 10 Vpp condition (see Table 2). As the voltage amplitude is decreased from 16 Vpp to 2 Vpp, the peaks become more separated but concurrently become wider. Consequently, resolutions of the separations do not differ significantly between the experiments. Thus, once a proper value for the offset voltage is selected, altering the voltage amplitude does not make a considerable difference in the separation performance of the system.

When the power to the system is discontinued, slightly more release of particles for 16 Vpp condition is observed. However, this discharge of particles is not significantly different as voltage amplitude is varied.

### Example 6

### Frequency Comparison

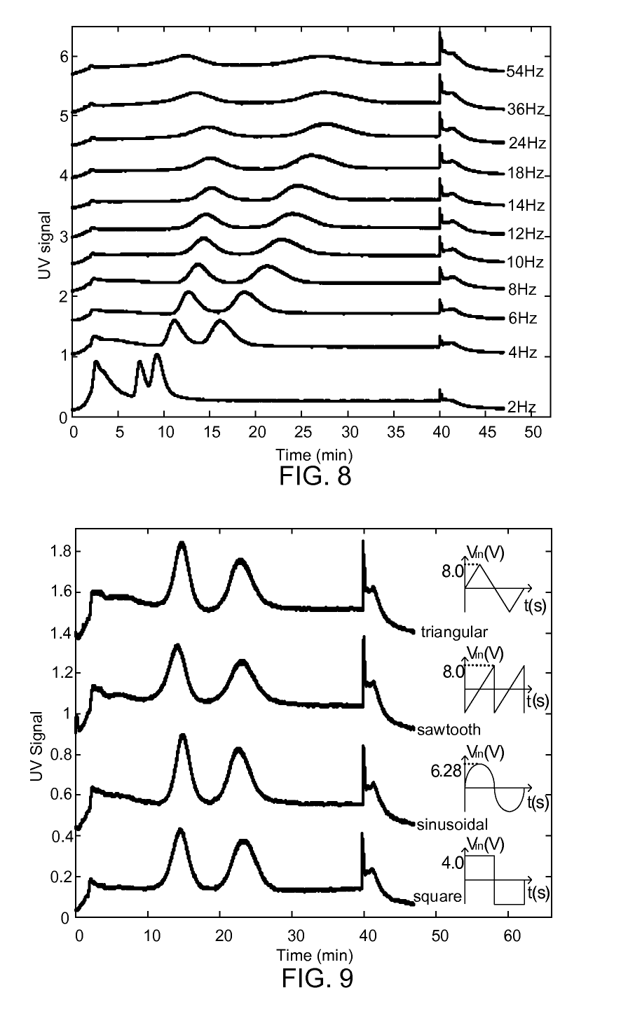

In FIG. 8, the UV fractograms depict the effect of altering the frequency on the separation efficiency. Using the modified CyEFFF circuit, frequencies ranging from 2 Hz to 54 Hz were applied, a voltage amplitude of 8 Vpp was used, and the offset value was Vₒₚₜᵢₘᵤₘ (1.4V).

For the very low frequency of 2 Hz, retention times of the particles were less than 10 minutes. Furthermore, the resolution of the separation was poor and baseline separation could not be achieved. However, at frequencies of 4 Hz and above, baseline separations of particles was observed. For higher frequencies, peak separations were bigger, but peak widths were also wider. Thus, separation quality was not affected by the application of high frequency voltages. In FIG. 8, slightly larger power-off responses at high frequencies was observed, which is likely due to a larger number of particle-surface interactions at high frequencies. Since nanoparticles interact more with the electrode surface at high frequencies, there is more chance for the particles to be trapped on the channel surfaces. As a result, more particles are released as voltages are powered off, which were cycling at high frequencies.

### Example 7

### Frequency Wave Comparison

In all the previous examples, the shape of the voltage waveform was selected as the square wave voltage. FIG. 9 shows the effect of using voltages of different shapes (sinusoidal, triangular and sawtooth) on separation performance, using the same modified CyEFFF circuit. The amplitudes used for the triangular, sawtooth, sinusoidal and square wave voltages were 16 Vpp, 16 Vpp, 12.57 Vpp and 8 Vpp respectively. Different amplitudes were selected to obtain the same amount of electric field during each cycle (i.e., the areas under the half period of the voltage waveforms became all the same). The other voltage parameters were f=10 Hz and Voffset=Vₒₚₜᵢₘᵤₘ. FIG. 9 demonstrates that there is no noticeable difference between the separation efficiencies of the experiments. Thus, the shape of the voltage does not affect the separation resolution when the integral of the applied voltage per half cycle is held constant.

To compare the fractionation performance of each experiment, separation resolutions were calculated according to:

$$Rs = \frac{{t}_{2} - {t}_{1}}{2 ( {σ}_{1} + {σ}_{2} )}$$

where t₁ and t₂ are the positions of the peaks and σ₁ and σ₂ are the standard deviations of the peaks as they are approximated to a Gaussian curve. Results are tabulated in Table 2 below.

In Example 2, using the modified CyEFFF circuit without the voltage offset results in about a four times improvement (from 0.3 to 1.19) in resolution compared to the regular circuit without offset voltage. When the 1.3 offset voltage is applied, the resolution obtained by the circuit modification method is about 2 times (0.59 to 1.19) the resolution. Combination of the circuit modification with the offset application method results in the highest resolution of 1.69. Additionally, the mean current (I_{EFFF}) values for each separation run was calculated. As expected, for the regular circuit with no-offset, the mean current calculated was 0 A. For the modified circuit with no-offset, the mean I_{EFFF} was 19 mA. This data suggests that the modified circuit helps to create a positive shift in the current and accordingly, in the effective electrical field. The mean current measured for the regular circuit with the 1.3V offset was 17 mA. The mean I_{EFFF} measured for the modified circuit with the 1.3V offset was 25 mA. As previously explained, an increase in the effective electrical field (i.e., E⁺_{eff}>E⁻_{eff}) makes high resolution separations possible. Example 2 supports this, since higher mean currents resulted in higher resolutions.

TABLE 2
Calculated separation resolutions
Example 2
(comparison of regular circuit and modified circuit in the presence and absence
of the offset voltage)

| No offset | No offset | 1.3 V offset | 1.3 V offset |
|---|---|---|---|
| (Regular Circuit) | (Modified Circuit) | (Regular Circuit) | (Modified Circuit) |
| 0.30 | 1.19 | 0.59 | 1.68 |

Example 3
(offset voltage comparison)

| 0 V | 0.2 V | 0.4 V | 0.6 V | 0.8 V | 1.0 V | 1.2 V | 1.4 V | 1.6 V | 1.8 V | 2.0 V |
|---|---|---|---|---|---|---|---|---|---|---|
| 0.52 | 0.64 | 0.71 | 0.74 | 0.91 | 1.27 | 1.55 | 1.62 | 1.61 | 1.59 | 1.30 |

Example 5
(voltage amplitude comparison)

| 2 Vpp | 4 Vpp | 6 Vpp | 8 Vpp | 10 Vpp | 12 Vpp | 14 Vpp | 16 Vpp |
|---|---|---|---|---|---|---|---|
| 1.39 | 1.47 | 1.53 | 1.56 | 1.53 | 1.48 | 1.43 | 1.40 |

Example 6
(frequency comparison)

| 2 Hz | 4 Hz | 6 Hz | 8 Hz | 10 Hz | 12 Hz | 14 Hz | 18 Hz | 24 Hz | 36 Hz | 54 Hz |
|---|---|---|---|---|---|---|---|---|---|---|
| 0.90 | 1.30 | 1.46 | 1.59 | 1.66 | 1.56 | 1.59 | 1.62 | 1.62 | 1.63 | 1.67 |

Example 7
(voltage shape comparison)

| Square | Sinusoidal | sawtooth | triangular |
|---|---|---|---|
| 1.66 | 1.65 | 1.60 | 1.69 |

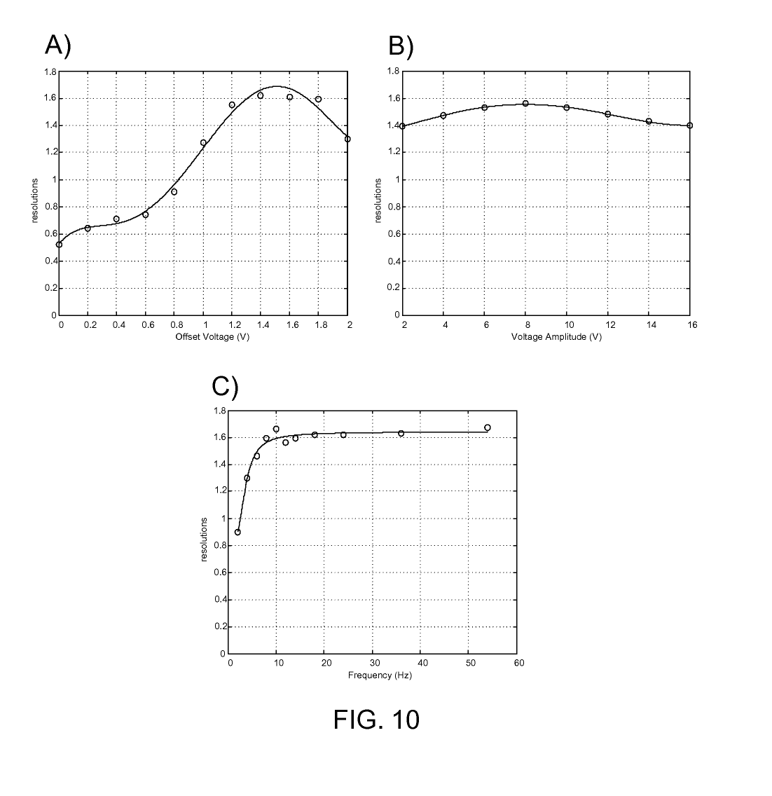

For better visualization of the results, resolutions obtained from the offset, amplitude and frequency comparison experiments were plotted in FIGS. 10(A. B, and C).

FIG. 10A shows that for offset values smaller than 1V, baseline separations could not be achieved (i.e., resolutions were smaller than 1.0). For offset voltages between 1.2V and 1.8 V high resolution separations were achieved; and finally, for offset values bigger than 1.8V, separation resolution declined. Therefore, a voltage offset value may be selected such that it is not too small or too high (i.e., between 1.2 to 1.8V for this experiment) to achieve high resolution separations.

FIG. 10B, shows resolutions obtained from the voltage amplitude comparisons. For voltage amplitudes from 2 Vpp to 16 Vpp, baseline separations were obtained in which the resolutions were greater than 1.38V. This example demonstrates that if a suitable offset voltage is selected (1.4V in this case), changing the voltage amplitude does not produce a significant improvement in separation performance.

FIG. 10C shows the relationship between frequency and separation resolution. For frequencies greater than 6 Hz, separation resolutions were very high—around 1.6. In earlier works, high frequencies (even frequencies greater than 10 Hz) were associated with band broadening and decreased separation efficiency. In contrast, using the modified circuit and voltage offset, high frequencies can be safely used in CyEFFF, without a reduction in separation performance. Moreover, availability of higher frequency application may lead to the fabrication of channels with shorter lengths because there is no more need for a longer channel when enough cycles can be obtained at higher frequencies.

Using different shapes of voltages did not appreciably affect separation resolution. Separation performances were all very similar and resolutions obtained were between 1.60 and 1.69. The highest resolution was obtained for the triangular waveform (1.69), and the lowest resolution corresponds to the sawtooth waveform (1.60). This data suggests that if the right amplitude for the waveform is chosen, as previously explained, the shape of the voltage waveforms will not have an appreciable effect on CyEFFF separations.

What is claimed is:

1. An EFFF or CyEFFF device, comprising:
a microfluidic system including a sample input port, a fluid flow channel, and a sample output port, the fluid flow channel defined by a pair of electrode walls and an insulator; and
a voltage device electrically coupled to the electrode walls, the voltage device comprising a diode or a resistor configured to provide electrical field within the fluid flow channel suitable for separation of nanoparticles from one another by causing a net effect of moving particles toward one of the electrode walls.

2. The device of claim 1, wherein the device includes both the diode and the resistor.

3. The device of claim 2, wherein the diode and the resistor are part of a parallel circuit.

4. The device of claim 3, wherein the device is configured to provide offset voltage to the electrode walls.

5. The device of claim 3, further comprising a second resistor in series with the parallel circuit.

6. The device of claim 3, wherein the resistor and the second resistor each have a resistance value from 0.1Ω to 50Ω.

7. The device of claim 3, wherein the resistor and the second resistor each have a resistance value from 1Ω to 10Ω.

8. The device of claim 1, wherein the resistor has a resistance value from 1Ω to 10Ω.

9. The device of claim 1, wherein the net effect of moving particles toward one of the electrode walls includes increased retention time of nanoparticles, wherein a first group of nanoparticles is slowed to a greater degree than a second group of nanoparticles.

10. The device of claim 1, wherein the electrode walls are solid electrode walls.

11. The device of claim 1, wherein the electrode walls comprise electrically porous material in contact with the fluid flow channel and having electrodes outside of the electrically porous material.

12. The device of claim 1, wherein the insulator is a pair of spacers, wherein the pair of spacers define two opposing sides of the fluid flow channel, and wherein the electrode walls define two opposing sides of the fluid flow channel.

13. The device of claim 1, configured so that at least a portion of the nanoparticles for separation are less than 100 nm in size.

14. The device of claim 13, configured so that a first group of nanoparticles less than 100 nm in size are separable from a second group of nanoparticles of a different size.

15. The device of claim 14, wherein the second group of nanoparticles are also less than 100 nm in size.

16. The device of claim 1, configured so that at least a portion of the nanoparticles for separation are less than 70 nm in size.

17. The device of claim 1, wherein the device is a CyEFFF device.

18. The device of claim 17, wherein the CyEFFF device is adapted to provide offset voltages the electrode walls.

19. The device of claim 1, wherein the device is an EFFF device.

20. The device of claim 19, wherein the EFFF device is adapted to provide offset voltages the electrode walls.

21. A method of separating nanoparticles, comprising:
flowing a nanoparticle dispersion including the nanoparticles through the fluid flow channel of an EFFF or CyEFFF device, the device including:
a microfluidic system including a sample input port, a fluid flow channel, and a sample output port, the fluid flow channel defined by a pair of electrode walls and an insulator, and
a voltage device electrically coupled to the electrode walls, the voltage device comprising a diode or a resistor configured to provide electrical field within the fluid flow channel suitable for separation of nanoparticles from one another by causing a net effect of moving particles toward one of the electrode walls; and
applying cyclic or DC offset voltage to the electrode walls to increase retention time of nanoparticles, wherein as the nanoparticles move toward one of the electrode walls, a first group of nanoparticles is slowed to a greater degree than a second group of nanoparticles.

22. The method of claim 21, wherein the nanoparticle dispersion includes nanoparticles of less than 100 nm.

23. The method of claim 22, wherein the first group of nanoparticles is less than 100 nm in size and is separable from the second group of nanoparticles of a different size.

24. The method of claim 23, wherein the second group of nanoparticles are also less than 100 nm in size.

25. The method of claim 22, wherein the first group of nanoparticles is larger in size than the second group of nanoparticles by at least 20 nm.

26. The method of claim 21, wherein the nanoparticle dispersion includes nanoparticles of less than 70 nm.

27. The method of claim 21, wherein the step of applying includes applying both cyclic and DC offset voltage to the electrode walls.

28. The method of claim 21, further comprising the step of applying an initial direct current voltage to attract the nanoparticles to one or both of the electrode walls prior to application of the offset voltage.

29. The method of claim 21, wherein mobility of the nanoparticles is based at least in part on size of the nanoparticles.

30. The method of claim 21, wherein the device is the CyEFFF device.

31. The method of claim 21, wherein the device is the EFFF device.

32. The method of claim 21, wherein the DC offset voltage is from 1.0V to 2.0V.

33. The method of claim 21, wherein the DC offset voltage is from 1.1V to 1.5.

34. The method of claim 21, wherein the DC offset voltage is from 1.3V to 1.4V.
